(19) United States
(12) Patent Application Publication
(10) Pub. No.: US 2018/0079672 A1
(43) Pub. Date: Mar. 22, 2018

(54) Systems and Methods for Processing Biogas

(71) Applicant: J.S. Meyer Engineering, P.C., Granite City, IL (US)

(72) Inventors: Stanley Marcus MEYER, Maryville, IL (US); Jason Scott MEYER, Collinsville, IL (US)

(73) Assignee: J.S. Meyer Engineering, P.C., Granite City, IL (US)

(21) Appl. No.: 15/269,784

(22) Filed: Sep. 19, 2016

(51) Int. Cl. C02F 11/04; C02F 3/28; C02F 1/32; C02F 1/44; C02F 1/00; C02F 1/38; B01D 53/14; B01D 53/047; B01D 53/84; B01D 53/52

(52) U.S. Cl. CPC C02F 11/04; C02F 2103/20; C02F 1/32; C02F 1/441; C02F 1/004; C02F 1/385; B01D 53/1475; B01D 53/047; B01D 53/84; B01D 53/52; B01D 53/1493; B01D 2252/103; C02F 2301/106; C02F 2303/02; C02F 3/286

(57) ABSTRACT

The present disclosure relates, according to some embodiments, to systems and methods for processing organic compounds, such as manure or other organic waste. Embodiments may comprise a first containment or mixing chamber, a first anaerobic chamber, and a second anaerobic chamber. A first anaerobic chamber may receive organic compounds from a first containment or mixing chamber, and may provide a fluid stream to a second anaerobic chamber. The second anaerobic chamber may comprise a substrate, such as lava rock, with bacteria growing thereon. Further, biogas generated in one or both of the first anaerobic chamber and the second anaerobic chamber may be purified in a first stage using a water scrubber to remove a majority of the carbon dioxide and other contaminants from the biogas, and in a second stage using a pressure swing adsorption unit to reduce carbon dioxide and other contaminants to pipeline acceptable levels. Further yet, carbon dioxide and hydrogen sulfide gases generated during the biogas purification process may be injected into a water-containing chamber in the presence of bacteria and oxygen to convert the hydrogen sulfide to elemental sulfur and/or sulfate

### CROSS-REFERENCE TO OTHER APPLICATIONS

The contents of U.S. Provisional Application No. 62/059,236 filed Oct. 3, 2014, and U.S. patent application Ser. No. 14/731,420 filed Jun. 5, 2015 are hereby incorporated in their entirety by reference.

### FIELD OF THE DISCLOSURE

The present disclosure relates, in some embodiments, to systems and methods for processing organic compounds, such as manure or other organic waste, and subsequent processing of resulting biogas. Some embodiments of the present disclosure process manure or organic waste through anaerobic digestion vessels, remove and process undesired compounds from the resulting biogas, and provide for odor control.

### BACKGROUND OF THE DISCLOSURE

Various organic compounds release unwanted and/or unpleasant odors. For example, animal manure or human waste may release odors that are unsanitary and may cause odor complaints. Treatment of organic compounds such as animal manure or human waste through processes such as aerobic digestion and/or anaerobic digestion may release sulfides. Such compounds may contribute to the aforementioned odors. Thus, treatment of organic compounds may often lead to offensive odors.

### SUMMARY

A need has arisen for an improved manure processing system that provides for improved odor control, yield improvement, and increased throughput. The present disclosure is related, in some embodiments, to systems and methods for processing organic compounds, such as manure or other organic material. According to some embodiments, a system and/or apparatus may comprise two anaerobic digestion chambers to increase yield and throughput. In some embodiments, a first anaerobic digestion chamber will utilize separation of the mesophilic processes to feed the second anaerobic chamber, which may utilize a thermophilic process. According to other embodiments, a system and/or apparatus may comprise a first containment chamber, a first anaerobic chamber, and a second anaerobic chamber. According to yet other embodiments, a system and/or apparatus may comprise one or more mixing chambers, a first anaerobic chamber, a second anaerobic chamber, and an aerobic reaction chamber. A first anaerobic chamber may receive organic compounds from a first containment chamber or one or more mixing chambers and/or may provide a fluid stream to a second anaerobic chamber. A second anaerobic chamber may comprise a substrate, such as lava rock, with bacteria growing thereon. Further, a sulfide gas treating unit may receive and/or treat sulfide gases from a first anaerobic chamber and/or a second anaerobic chamber. In other embodiments, sulfide-containing gases may be injected into an aerobic reaction chamber or pond to promote the biological conversion to sulfates and elemental sulfur. In some embodiments, generated biogas may be purified using one or more processes, including but not limited to water scrubbing and pressure swing adsorption. In certain embodiments, generated biogas will be purified using water scrubbing before being further purified using pressure swing adsorption to remove carbon dioxide and other contaminants such as hydrogen sulfide and ammonia. A water storage unit may receive and store water or effluent from a first anaerobic chamber and/or a second anaerobic chamber.

In some embodiments, a first containment chamber may be or comprise a hog barn or a portion thereof. A first containment chamber may comprise, for example, sloped pits and slatted floors disposed above trenches. Organic materials treated may comprise animal manure. A first anaerobic chamber may be or comprise a lagoon. A first anaerobic chamber may be configured to operate at temperatures of about 32° F. to about 240° F., and pressures of about 0 psig to about 10 psig. A second anaerobic chamber may be configured to operate at temperatures of about 50° F. to about 800° F., and pressures of about 0 psig to about 1200 psig. A first anaerobic chamber may be configured to operate at lower temperatures and/or pressures than the second anaerobic chamber. In some embodiments, an oxidizer may be disposed within a water storage unit. An oxidizer may be selected from the group consisting of potassium permanganate, sodium permanganate, hydrogen peroxide, and any combinations thereof. In some embodiments, a sulfide gas treating unit may also be in fluid communication with a first anaerobic chamber, and may receive and treat sulfide gases from a first anaerobic chamber. Similarly, a water storage unit may also be in fluid communication with a first anaerobic chamber, and may receive and store water or effluent from the first anaerobic chamber. In some embodiments, a system comprises no additional anaerobic chambers other than a first anaerobic chamber and a second anaerobic chamber.

The present disclosure relates, in some embodiments, to methods for processing organic compounds. For example, a method may comprise collecting in a first containment chamber organic compounds; receiving at a first anaerobic chamber the organic compounds from the first containment chamber; treating in the first anaerobic chamber the organic compounds; providing from the first anaerobic chamber a fluid stream; receiving the fluid stream at a second anaerobic chamber, wherein the second anaerobic chamber comprises a substrate with a microorganism (e.g., bacteria) growing thereon; receiving, from the second anaerobic chamber, sulfide gases at a sulfide gas treating unit; and receiving, from the second anaerobic chamber, water at a water storage unit.

### BRIEF DESCRIPTION OF THE DRAWINGS

Some embodiments of the disclosure may be understood by referring, in part, to the present disclosure and the accompanying drawings, wherein:

FIG. 1 illustrates an example system according to a specific example embodiment of the present disclosure;

FIG. 2 illustrates another example system according to a specific example embodiment of the present disclosure;

FIG. 3 illustrates a first anaerobic digestion chamber according to a specific example embodiment of the present disclosure;

FIG. 4A illustrates an aerial view of a section of a first containment chamber according to a specific example embodiment of the present disclosure;

FIG. 4B illustrates a cross-sectional view of a section of a first containment chamber according to a specific example embodiment of the present disclosure; and

FIG. 5 illustrates another example system according to a specific example embodiment of the present disclosure.

### DETAILED DESCRIPTION

The present disclosure relates, in some embodiments, to systems and methods for processing organic compounds. According to some embodiments of the present disclosure, systems and/or methods may be suitable for processing any desired organic compounds. For example, systems and methods of the present disclosure may be suitable for treating organic waste such as animal manure, human waste, or other types of organic waste.

According to some embodiments, organic compounds to be treated may be provided from a particular source. For example, a holding pit may be used to gather targeted organic compounds. Waste from an animal confinement area may be sluiced or otherwise gathered into a container such as a holding pit. Organic compounds, including but not limited to manure, dead animals, cellulosic matter, grasses, whey, and buttermilk, may also be collected in one or more mixing pits or tanks, mixed together, and combined with clean water and/or recycled fluids. Mixing may be accomplished by agitation or other means. The organic compounds may also be treated with ultrasound in one or more of the mixing tanks to break cell walls or barriers and increase biogas availability. In some embodiments, bacteria-containing fluid recycled from subsequent processes can be added to the organic material in one or more of the mixing pits or tanks to provide intimate contact between the organic material and bacteria. Organic compounds from multiple sources may also be mixed together and/or with clean water and/or recycled fluid using in-line static mixers.

Organic compounds, such as animal manure, may then be provided to a first anaerobic digestion chamber. Organic compounds may be provided to a first anaerobic digestion chamber via various mechanical mechanisms, such as a fluid pipeline. A fluid pipeline connecting a container and a first anaerobic digestion chamber may serve as a feed stream. In such a manner, a fluid connection may be established between a container, such as a holding or mixing pit, and a first anaerobic digestion chamber. A pump may be disposed on a feed stream and may be used to facilitate transferring of organic compounds from a container to a first anaerobic digestion chamber. A pump may be operated from about 2 psig to about 1500 psig. In some embodiments, a pump may be operated at about 1200 psig.

A first anaerobic digestion chamber according to some embodiments of the present disclosure may be a closed vessel. As used herein, a closed vessel may refer to an operating environment or a chemical reaction environment wherein fluids such as gases and liquids may not enter or escape the environment unless otherwise provided by a particular feed stream or exit stream. For example, a closed vessel may capture any gases released by chemical reactions occurring within the vessel. A closed vessel may also advantageously maintain a particular operating temperature and/or pressure. In some embodiments, a first anaerobic digestion chamber as utilized in the present disclosure may be air tight. An air tight chamber may advantageously prevent any hydrogen sulfide gas emission into the atmosphere and thereby reduce unwanted odors.

In some embodiments, a first anaerobic digestion chamber as described herein may be a lagoon. A lagoon may receive or otherwise contain organic compounds for processing through the systems and methods described in the present disclosure. A holding or mixing pit may pre-process and mix organic compounds, such as manure, prior to charging it to a lagoon or a first anaerobic digestion chamber. For instance, different types of feed or organic matter having different compositions of total solids may be mixed in certain amounts to control the composition of total solids at any desired value. Clean water or recycled fluid may also be added to the organic compounds to control the composition of total solids at any desired value. In some embodiments, the composition of total solids can be controlled at about 20% in a first mixing stage and about 5% in a second mixing stage by the combination of different types of feed, clean water, and/or recycled fluid in certain amounts. In other embodiments, the composition of total solids can be controlled to be as high as 60% or higher or as low as 2-10% or lower by the combination of different types of feed, clean water, and/or recycled fluid in certain amounts.

A first anaerobic digestion chamber may receive organic compounds, such as animal manure, from a container, such as a holding or mixing pit. Organic compounds processed in the first anaerobic digestion chamber may result, via chemical reactions, in the production of various biogases such as methane, carbon dioxide, hydrogen, nitrogen, ammonia, oxygen, and sulfides. These and other minor constituents may collectively be referred to as biogas. Organic compounds may be processed in the first anaerobic digestion chamber at about 0 psig to about 10 psig, and about 32° F. to about 240° F. In some embodiments, a first anaerobic digestion chamber may be operated at any desired pressure including, for example, negative pressures. Operating pressures for a first anaerobic digestion chamber that may be as low as, for example, about −5 psig. In other embodiments, a first anaerobic digestion chamber may be operated under mesophilic conditions, with temperatures ranging from 32 to 110° F. and pressures ranging from −5 to 150 psig. Without limiting the scope of the disclosure to any particular mechanism of action, negative pressure may advantageously remove oxygen from the vapor space, and may increase the efficiency of the second step of the anaerobic digestion. For example, where the first anaerobic digestion chamber is a lagoon, running it at negative pressures may keep the lagoon cover low and against the surface of the liquid in the lagoon, protecting it from debris. A first anaerobic digestion chamber may have a volume of about 1,000 gallons to, in some embodiments, over 25 million gallons. A first anaerobic digestion chamber may process organic compounds for several hours. For example, in some embodiments, organic material may remain in a first anaerobic digestion chamber for about 15 minutes. In some embodiments, organic material may remain in a first anaerobic digestion chamber for up to about seven years. In other embodiments, liquid organic material may remain in a first anaerobic digestion chamber for one to two months, while solid organic material may remain in a first anaerobic digestion chamber for three to six months.

Processing organic compounds in a first anaerobic digestion chamber may produce biogas, including methane and sulfide gases. Embodiments of the present disclosure may advantageously provide a mechanism to process and control said gases.

Biogas may be captured in a vapor space of a sealed first anaerobic digestion chamber. Then, biogas may be removed from a first anaerobic digestion chamber by, for example, a blower or compressor. Outlet pressures of the blower or compressor may range from about 0 psig to about 300 psig or higher. Collected biogas may further be used to produce at least some of the energy required to pressurize other components in the processing system, such as a second anaerobic digestion chamber. For example, biogas may be used to provide at least part of the energy needed to operate a compressor. Biogas may also be used to provide heating of system components via combustion of said biogas.

Sulfide gases, such as hydrogen sulfide, may be absorbed by a chemical scrubber. Various types of chemical scrubbers or other appropriate techniques may be used to provide for absorption of sulfide gases. For example, sulfide gases may be passed through a bed of finely divided iron oxide. In some embodiments, sulfide gases may be absorbed through use of ferrous sulfate. Other suitable processes may include scrubbing with caustic solution, amine scrubbing, and/or permanganate scrubbing. Some embodiments of the present disclosure may utilize a biogas iron filings unit. A biogas iron filings unit may advantageously convert sulfides gases, such as hydrogen sulfide, to iron sulfide. Usage of the various methods described above may result in significantly reduced hydrogen sulfide gas emissions to the atmosphere. In some embodiments, hydrogen sulfide gas emissions, if any, may be less than detectable. In some embodiments, biogas may be passed through a chemical scrubber prior to using it to power various components of the system described herein, including, for example, a compressor.

Solids may be separated from a first anaerobic digestion chamber and/or a second anaerobic digestion chamber and/or an aerobic reaction chamber via gravity separation. In some embodiments, mechanical devices or mechanisms may be used to facilitate separating or removal of solids from the first anaerobic digestion chamber and/or the aerobic reaction chamber. For example, a vacuum truck may be used to remove solids that have settled to the bottom of a first anaerobic digestion chamber and/or an aerobic reaction chamber. Such mechanical devices or mechanisms may be incorporated into systems of the present disclosure as appropriate to separate an amount of solids from the first anaerobic digestion chamber and/or an aerobic reaction chamber. Solids separated or removed from the first anaerobic digestion chamber, second anaerobic digestion chamber, and aerobic reaction chamber may comprise cellulose, carbohydrates, proteins, lipids, phosphorus, ammonium, and potassium oxide. Separate or removed solids may then be suitable for use as fertilizers.

Liquids may be collected during processing of organic compounds within a first anaerobic digestion. For example, water may be collected. Water in a first anaerobic digestion may be rich in various nutrients, for example, carbohydrates, proteins, lipids, phosphorus, ammonium, and potassium oxide. Liquids, such as the aforementioned water from the first anaerobic digestion chamber, may be transferred to a second anaerobic digestion chamber via various mechanical mechanisms, such as a fluid pipeline. In such manner, a fluid connection may be established between a first anaerobic digestion chamber and a second anaerobic digestion chamber. In some embodiments, a pump may be used to facilitate transferring of organic compounds from a first anaerobic digestion chamber to a second anaerobic digestion chamber. Further, in some embodiments, a heat exchanger may be disposed along the fluid pipeline. A heat exchanger may be disposed downstream from a pump on the pipeline to facilitate transferring of liquids, such as water, from a first anaerobic digestion chamber to a heat exchanger, and then to a second anaerobic digestion chamber. A pump and a heat exchanger may operate at various pressures and temperatures. For example, in some embodiments, a pump and a heat exchanger may operate at about 1200 psig and about 567° F. In some embodiments, a pump and a heat exchanger may operate at about 600 psig and about 490° F. In some embodiments, a pump and a heat exchanger may operate at about 300 psig and about 421° F. In some embodiments, a pump and a heat exchanger may operate at about 150 psig and about 366° F. In some embodiments, a pump and a heat exchanger may operate at about 15 psig and about 250° F.

A first anaerobic digestion chamber may convert about 10% to about 80% or more of organic compounds received, such as volatile solids, to methane and carbon dioxide. The resulting gases may be at ratios of about 25% to about 35% carbon dioxide and 50% to about 70% methane.

A second anaerobic digestion chamber may receive a fluid stream, such as water from a first anaerobic digestion chamber. A second anaerobic digestion chamber may facilitate the production of methane gases therein. A second anaerobic digestion chamber may be operated at conditions that emulate environments suitable for the production of natural gases, such as methane, in geologic settings. In some embodiments, a second anaerobic digestion chamber may be operated at high temperatures and high pressures. A second anaerobic digestion chamber may operate at higher temperatures and/or higher pressures than a first anaerobic digestion chamber of the present disclosure. In some embodiments, a second anaerobic digestion chamber may be operated at about 50 to about 800 degrees Fahrenheit and about 0 to about 1200 psig. In some embodiments, a second anaerobic digestion chamber may be operated at about 70 degrees Fahrenheit and about 1200 psig. The high temperature and high pressure of a second anaerobic digestion chamber may advantageously increase chemical reaction rates within said chamber. Higher temperatures may increase reaction rates within the chamber by approximately two times for every increase of about 2 degrees Fahrenheit to about 18 degrees Fahrenheit. Increasing reaction rates may advantageously reduce the necessary residence time in a chamber.

A second anaerobic digestion chamber may convert about 10% to about 80% or more of organic compounds received, such as volatile solids, to methane and carbon dioxide. The resulting gases may be at ratios of about 15% to about 40% carbon dioxide and 60% to about 85% methane.

In some embodiments, operating temperatures for a second anaerobic digestion chamber may exceed sterilization temperatures. Such temperatures may advantageously result in solid materials that are more suitable for application to land as fertilizers. Further, the high operating temperatures may advantageously destroy all bacteria except particular varieties that can thrive in high pressures and high temperatures—bacteria normally found deep underground in similar temperatures and pressure environments. A second anaerobic digestion chamber may process organic compounds, such as a water stream, for several hours. For example, a second anaerobic digestion chamber may have a retention time ranging from about 20 minutes to about 22 days.

A second anaerobic digestion chamber may comprise porous rocks disposed within the chamber. The porous rocks may advantageously provide for a large surface area within the chamber. Various types of porous rocks may be suitable. For example, lava rock may be used in some embodiments of the present disclosure.

The porous rocks, in conjunction with the high operating temperatures and high operating pressures, may serve as a suitable substrate for bacteria to grow on. Such operating conditions may advantageously emulate conditions that promote bacteria growth. Bacteria in a second anaerobic digestion chamber may remove much of the nutrients from a water stream in the second anaerobic digestion chamber. Bacteria may also advantageously lower the biological oxygen demand by at least an order of magnitude, if not greater.

Liquids, such as water, may pass over a surface of a substrate, such as porous rock, and may be contained in a second anaerobic digestion chamber for a period of time. In some embodiments, water received into a second anaerobic digestion chamber may be processed for a time period ranging from about 20 minutes to about 22 days.

Similar to a first anaerobic digestion chamber of the present disclosure, processing organic compounds in a second anaerobic digestion chamber may produce biogas. Biogas formed in a second anaerobic digestion chamber may also be collected through capture in the vapor space of the sealed second anaerobic digestion chamber followed by removal from the second anaerobic digestion chamber by, for example, a blower or compressor. Additionally and/or alternatively, the biogas may be removed from the second anaerobic digestion chamber through simple flow from a high-pressure zone to a low pressure zone. Outlet pressures of the blower or compressor may range from about 0 psig to about 300 psig. Collected biogases may further be used to produce at least some of the energy required to pressurize various components in the processing system, including the second anaerobic digestion chamber. For example, biogases may be used to provide at least part of the energy needed to operate a compressor. Biogases may also be used to provide heating of system components via combustion of said biogases.

In some embodiments, biogases collected from a first anaerobic digestion chamber and a second anaerobic digestion chamber may be combined and processed together. In some embodiments, biogases collected from a first anaerobic digestion chamber and a second anaerobic digestion chamber may be treated separately.

Embodiments of the present disclosure may advantageously make use of a condenser and/or a condensate receiver. After leaving a blower or compressor, biogas may pass through a condenser to remove heat gained in the compression process and to condense water vapor from the biogas. A condenser may be of various types, including, in some embodiments, a ground cooler, an air-cooled heat exchanger, or a liquid-cooled heat exchanger. Condensate from the condenser may be collected and returned to the first anaerobic digestion chamber or a second anaerobic digestion chamber or collected for cleaning purposes. In some embodiments, biogas collected from a first anaerobic digestion chamber and a second anaerobic digestion chamber may be combined and processed together. In some embodiments, biogas collected from a first anaerobic digestion chamber and a second anaerobic digestion chamber may be treated separately.

Sulfide gases generated in a second anaerobic digestion chamber may also be treated. In some embodiments, sulfides may be removed and stored as appropriate. In some embodiments, sulfides may be absorbed by a chemical scrubber. Various types of chemical scrubbers or other appropriate techniques may be used to provide for absorption of sulfide gases. For example, sulfide gases may be passed through a bed of finely divided iron oxide. Other suitable processes may include scrubbing with caustic solution, amine scrubbing, and/or permanganate scrubbing. In some embodiments, sulfide gases collected from a first anaerobic digestion chamber and a second anaerobic digestion chamber may be combined and processed together. In some embodiments, sulfide gases collected from a first anaerobic digestion chamber and a second anaerobic digestion chamber may be treated separately.

Processing sulfide gases, for example, as provided herein, may result in conversion of 99.9% of hydrogen sulfide initially present in the stream or initially collected from a first anaerobic digestion chamber and a second anaerobic digestion chamber. Removal of hydrogen sulfide content may help satisfy natural gas product quality standards. Converted gas containing, for example, methane, carbon dioxide, hydrogen, nitrogen, ammonia, and oxygen, may then be stored in inflatable bladders. In some embodiments, scrubbing, chemical absorption, pressure swing adsorption (PSA), membrane purification, cryogenic separation, or additional biological processes may be used to further purify the biogas. For example, the biogas may be scrubbed with water or polyethylene glycol under high pressure to move impurities, such as carbon dioxide and hydrogen sulfide, into the liquid stream. Additionally or alternatively, the biogas may be cleaned by chemical absorption using, for example, aqueous solutions of amines or alkaline salts (the alkaline hydroxides). Additionally or alternatively, the biogas may be cleaned using a PSA unit to deposit impurities on a zeolite or activated carbon molecular sieve. Additionally or alternatively, the biogas may be selectively passed through a membrane which allows some components of the biogas through while others are retained on or in the membrane. Additionally or alternatively, the biogas may be cryogenically separated into its constituents based upon the different temperature/pressure combinations that each component liquefies at. Additionally or alternatively, the biogas may be sent through a bed or suspension of bacteria which may consume impurities in the biogas preferentially.

Biogases collected from a first anaerobic digestion chamber and/or a second anaerobic digestion chamber may be further purified. For example, scrubbing, chemical absorption, pressure swing adsorption (“PSA”), membrane purification, cryogenic separation, or additional biological process may further purify biogases. In some embodiments, methane gas leaving, for example, a PSA unit may have less than about 3.99 ppm hydrogen sulfide, about 0.2% or less oxygen by volume, and about 1% or less carbon dioxide by volume, with a heating value of not less than about 950 Btu/cubic foot. After this purification, the resulting cleaned methane gas may be further compressed to a high pressure. For example, methane gases collected may be compressed from about 3200 psig to about 7400 psig. Compressed methane gases may then be off loaded at gas line injection sites.

In some embodiments, biogases collected from a first anaerobic digestion chamber and/or a second anaerobic digestion chamber may be purified using one of two primary methods of purifying biogas (i.e., separating carbon dioxide from methane): by adsorption by a fixed media (pressure swing adsorption or PSA) or by absorption in water. Both systems have their advantages and disadvantages. The water system uses scrubbing columns to absorb the carbon dioxide into the water from the gas stream. The solubility of the carbon dioxide in water is enhanced by lower temperatures and higher pressures. The system uses low cost materials and can produce pipeline gas, but it is hard to control and needs significant overdesign to ensure pipeline quality gas is achieved. However, for up to about 95% removal the process works well to remove the carbon dioxide. Removal of the last bit of carbon dioxide is significantly more difficult and significantly more work intensive. It is akin to approaching a pinch point in distillation design: stages where the operating and equilibrium lines are far from one another make great strides in separation; as the lines close in on one another, the stages make smaller and smaller steps towards separation and more stages are required. It is similar in biogas purification by water scrubbing: the majority of the cost, both in size and rate, is for the removal of the last bit of carbon dioxide to meet the pipeline quality of less than 2% carbon dioxide in the gas.

The fixed adsorption media is a material similar to a catalyst; its function is controlled by the pore sizes and pore volume of the media. The pore size determines which molecules are adsorbed and the pore volume determines the capacity of the media. The media design determines which molecule it retains. The adsorption of molecules onto the media limits the rate for the adsorbing unit; this fact can be critical in the selection of which gas should be adsorbed. There are many systems in industry which can either adsorb the carbon dioxide or the methane allowing the other gas to pass through. The concentration of carbon dioxide in biogas can be from about 30% to about 50%, while the concentration of methane makes up the bulk of the difference. There are small amounts of other gases in the biogas as well. A biogas purification unit can have two or more chambers; these chambers can be pressurized and/or depressurized depending on the stage of the cycle. Adsorption occurs during the pressurization stage and desorption occurs during the depressurization stage. The chambers are pressurized to improve the adsorption capacity of the media.

Combining two biogas processing techniques instead of using just one of the processes may lower the cost and improve the reliability of the production of pipeline quality gas. In one embodiment, biogases collected from a first anaerobic digestion chamber and/or a second anaerobic digestion chamber may be purified by water scrubbing prior to the use of an adsorption media for the production of pipeline quality gas. In some embodiments, after the biogas has been compressed, but before the biogas goes through the adsorption/desorption stages, it can be scrubbed with water to remove up to or about 95% of the carbon dioxide. Not having to achieve pipeline quality gas in the scrubber will reduce the size of the scrubber required. The reduction in carbon dioxide content of the gas will in turn minimize the size of the fixed media adsorption unit or allow a given adsorption unit to purify biogas at a higher rate with improved quality. The combination of these two processes will reduce the overall costs of the purification step of biogas processing.

The purification of natural gas to remove hydrogen sulfide is accomplished by several methods. The use of amine, iron salts, permanganate scrubbing, scrubbing with caustic, or direct combustion to sulfur dioxide, are common in the industry. The new biochemical production of “biogas” through anaerobic digestion of organic wastes produces a stream of primarily methane and carbon dioxide with ppm amounts of hydrogen sulfide. The concentration of the biogas contains from low ppm levels of less than 10 to higher levels up to 5000 ppm, depending upon the feed material to the digester and the process used.

Biogas is typically 60% to 70% methane and 30% to 40% carbon dioxide with the largest contaminate being hydrogen sulfide. There are two primary methods of purification of biogas to pipeline quality gas which is better than 95% methane and also removing the hydrogen sulfide. The first of these is water scrubbing and the second is pressure swing absorption. Both processes produce a carbon dioxide rich gas stream with elevated levels of hydrogen sulfide that need to be treated. The hydrogen sulfide level in that stream is elevated to approximately three times the level in the biogas feed stream. In various embodiments, the hydrogen sulfide containing stream can be treated with any of the above mentioned processes. The most common associated with biogas treatment is oxidation of the hydrogen sulfide to sulfur dioxide. However, this process is costly and results in an unwanted stream considered to be a primary air pollutant. As an alternative embodiment, the hydrogen containing stream may be injected into a holding vessel which may or may not be a lagoon or pond for the water and salts after the anaerobic digestion is completed. Certain bacteria will thrive in this material which when injected with the hydrogen sulfide and carbon dioxide stream will convert the hydrogen sulfide to elemental sulfur and sulfate at atmospheric conditions.

Similar to a first anaerobic digestion chamber of the present disclosure, solids in a second anaerobic digestion chamber may be separated and/or removed via gravity separation. In some embodiments, mechanical devices or mechanisms may be used to facilitate separating or removal of solids from a second anaerobic digestion chamber. For example, a vacuum truck may be used to remove solids that have settled to the bottom of the second anaerobic digestion chamber. Solids separated or removed from a second anaerobic digestion chamber may primarily comprise cellulose, carbohydrates, proteins, lipids, phosphorus, ammonium, and potassium oxide. Separate or removed solids may then be suitable for use as fertilizers.

Liquids, such as water, that has been passed over a substrate, such as porous rock, may then be discharged from a second anaerobic digestion chamber. Discharged liquid may be transferred via a discharge stream. A pump may be disposed along a discharge stream to facilitate transfer of the discharged liquids within the discharge stream. A heat exchanger may also be used to cool the discharge stream. In some embodiments, a discharge stream may run countercurrent to a feed stream entering a first anaerobic digestion chamber. A countercurrent arrangement of a discharge stream and a feed stream may advantageously cool fluids or effluent in the discharge stream while heating organic compounds in the feed stream. Thus, a countercurrent arrangement of a discharge stream and a feed stream may advantageously reduce heating and cooling requirements and costs associated thereto. Once temperature and pressure in the discharged liquids has been reduced, the resulting liquids and gases may be collected. These liquids will contain minor amounts of organics and organic acids, phosphorus, ammonium, and potassium oxide. Collection of ammonia as an off-gas may be a possibility.

In some embodiments, effluent from a second anaerobic digestion chamber may be further treated upon discharge. For example, effluent from a second anaerobic digestion chamber may be passed through an oxygenation system such as a bubbler or a spray arrangement. Such treatment of an effluent stream may advantageously re-oxygenate the fluids and further reduce the biological oxygen demand. In this manner, an effluent stream may more readily meet environmental standards for discharge.

A second anaerobic digestion chamber may convert about 10% to about 80% or more of organic compounds received, such as volatile solids, to carbon dioxide and methane at conventional ratios of about 50% to about 70% methane and about 30% to about 50% carbon dioxide. Use of a first anaerobic digestion chamber as described above and a second anaerobic digestion chamber may result in an increased yield of about 99% biogas from organic compounds, such as volatile solids.

A second anaerobic digestion chamber may increase the ability of a first anaerobic digestion chamber, such as a lagoon, to convert other carbon sources to biogas. Temperature and pressure in a second anaerobic digestion chamber may be better suited to the bacteria performing the methanogenesis process that generates the methane component of the biogas. When recycled, the liquid from a second anaerobic digestion chamber to a first anaerobic digestion chamber may serve as a diluent to the liquid in a first anaerobic digestion chamber, returning unreacted reactants in the liquid phase to a first anaerobic digestion chamber. The products of a second anaerobic digestion have been removed from this stream as undissolved biogas. Through the dilution of the products of anaerobic digestion in the first anaerobic digestion chamber, chemical equilibriums in the chamber may be shifted to generate more products. Additional carbon sources may also be added to a first anaerobic digestion chamber for conversion to biogas. Such carbon sources may include animal or vegetable fats, and livestock mortalities.

In some embodiments, systems of the present disclosure may utilize a water recycle system to improve water efficiency, reduce operating costs, and reduce the discharge of water treated by the currently disclosed systems and methods thereof. For example, water effluent from a second anaerobic digestion chamber may be recycled back into a first anaerobic digestion chamber to agitate compounds in the first anaerobic digestion chamber. Such recycling may advantageously increase reaction rates in the first anaerobic digestion chamber.

Recycled water may also be suitable for land application. For example, a side stream relative to a second anaerobic digestion chamber may be utilized to transfer fluids for land application. Such transfer may be performed routinely at predetermined intervals. For example, water may be transferred from a side stream annually or bi-annually. Water transferred in such manner may be sterilized by the high operating temperatures of a second anaerobic digestion chamber. A second anaerobic digestion chamber operating at above about 140 degrees Fahrenheit may sterilize water for purposes of land application. In some embodiments, an additional sterilization step may be used to improve suitability of water transferred for land application and to reduce risk of pathogen contamination.

In some embodiments, an amount of recycled or purified water may be drawn off by a side stream and stored for land application. For example, about 15 gallons per minute of recycled or purified water may be drawn off from the side stream. The amount drawn off may depend on the amount necessary to balance water input for a first anaerobic digestion chamber. The recycled or purified water may be particularly suitable for land application because the water may be pathogen free and may still contain all of the phosphate and potash value as fertilizer. Further, the water may also contain some nitrogen value as fertilizer.

Embodiments of the present disclosure may also comprise air handling units to regulate air flow and reduce unwanted odor emissions. In some embodiments, an air handling unit may draw recycled and conditioned air. An air handling unit may capture any hydrogen sulfide gases emitted from organic compounds, such as animal manure and wash water. Captured hydrogen sulfide gases may then be processed to prevent the hydrogen sulfide gases from venting to the atmosphere or recycling to the hog barn. Various types of chemical scrubbers or other appropriate techniques may be used to provide for absorption of sulfide gases. For example, sulfide gases may be passed through a bed of finely divided iron oxide. Other suitable processes may include scrubbing with caustic solution, amine scrubbing, and/or permanganate scrubbing. Other chemical treatment or scrubbing systems may also be suitable. The use of air handling units may further reduce any unwanted odor emissions.

Hog barns may place hogs on slatted floors above trenches and sloped pits, allowing the hogs to defecate freely with the manure falling through the slats. In some embodiments, air would be pulled from the space beneath the slatted floor but above the level of the manure and then cycled to the roof of the hog barn in ducts. On the roof of the hog barn, the blower providing the motive force for the suction may push the air through the sulfide scrubber. The scrubbed air may be ejected to the atmosphere or a portion of it may be recycled through a Heating, Ventilation, and Air Conditioning (HVAC) unit back into the hog barn. In some embodiments, air purified based on the above mentioned processes may be heat exchanged with incoming air. For example, a recuperative heat exchanger may be used to capture the heat value of the air that has passed through the chemical scrubber before it is vented to the atmosphere, thereby heating the incoming air and allowing a reduction in heat load for ventilation from about 50% to about 75%.

The HVAC unit may also be located on the roof. In some embodiments, an evaporative cooler may use the heat demand of evaporating water to cool air when dew point temperatures allow. Makeup air may be taken from the atmosphere at a point away from the scrubbed air outlet to the atmosphere. The air from the HVAC unit may be introduced into the hog barn at the ceiling level, creating a top-down air flow so that odors and hydrogen sulfide concentrations may be kept at a minimum or significantly reduced near floor level.

As discussed above, one or more air handling units may capture hydrogen sulfide gases and other odor causing gases. In some embodiments, a heating and/or ventilation system may be configured as a laminar flow system, whereby return air or recycled air can be fed into the system from the roof. Feeding return air at or near the roof may provide for a downwards air flow, thus minimizing hydrogen sulfide concentrations in a living space, and preventing odor causing gases from escaping the chamber. Floor level may be suitable as a living space for hogs, and thus reduction of odors and hydrogen sulfide concentrations may advantageously improve living conditions for said hogs.

Several bays of hogs in a barn may be serviced by each of these systems. For example, a single system of ducts, blower, chemical scrubber, and HVAC unit may be used to service about 4 bays in a hog barn. In some embodiments, large hog barns may be served by multiple instances of this system located on the roof.

In some embodiments, water effluent from a second anaerobic digestion system may be used to clean a system of the present disclosure. Alternatively and/or additionally, fresh water can be used to clean a system. Such cleaning of the facilities and the system may advantageously provide for odor control. Further odor control may be achieved with periodic cleaning of a facility or a system of the present disclosure.

In some embodiments, oxidizers may be added to a wash water, such as recycled water effluent or fresh water. Oxidizers may retard the formation of septic wastes prior to their introduction into a system of the present disclosure. Oxidizers used may include, but are not limited to, potassium permanganate, sodium permanganate, hydrogen peroxide, or any combination thereof. Use of said oxidizers may advantageously prevent the growth of odor causing bacteria and may reduce the overall odor of the operation. Use of said oxidizers may also advantageously reduce odor-causing sulfides within a system.

The present disclosure also allows for flushing of an anaerobic digestion chamber. For example, as previously explained, a first anaerobic digestion chamber may be a lagoon configured for use in conjunction with a hog barn. Wash water, such as recycled water effluent or fresh water, may be used to flush a lagoon to clean the facilities and maintain a sanitary environment. If recycled water effluent is used, a storage mechanism may be provided to store recycled water effluent so that a particular amount may be collected prior to being used for flushing. Recycled water effluent may be collected for periods of, for example, about two hours to about four days, prior to being used for flushing. Further, in some embodiments, a first anaerobic digestion chamber, such as a lagoon, may have sectional divisions or partitions so that water may flush only specific sections of a lagoon. For example, a lagoon may be segmented into sections which are sequenced when flushed. In this manner, the overall amount of water used for the cleaning process may be reduced.

Depending on the size of a lagoon, and the size of partitioned sections of a lagoon, the water requirement may differ. In some embodiments, 150,000 gallons water per day may be required for flushing or cleaning of a hog barn. Such a system may have a second anaerobic digestion chamber producing about 120,000 gallons of sterilized water per day that may be suitable for use as recycled water effluent. Thus, the production of sterilized water from the second anaerobic digestion chamber would satisfy the wash water requirements of a first anaerobic digestion chamber.

Routine cleaning and flushing of a first collection chamber, such as a holding pit, may reduce the buildup of hydrogen sulfide concentrations within a system of the present disclosure. Similarly, routine cleaning and flushing of a first anaerobic digestion chamber and/or a second anaerobic digestion chamber may reduce the buildup of hydrogen sulfide concentrations. Routine cleaning and flushing may reduce and limit buildup of hydrogen sulfide from non-detectable amount to about 10 ppm. A reduction in hydrogen sulfide content may improve environmental conditions and tolerability. For example, a lagoon with lower hydrogen sulfide may be advantageous for both hogs disposed near the lagoon, and for farmers who may operate the lagoon.

In some embodiments, a first collection chamber, such as a holding pit, may be insulated with a high-density polyethylene (HDPE) coating. Similarly, a first anaerobic digestion chamber and/or a second anaerobic digestion chamber may be insulated with an HDPE coating. Insulation provided by HDPE may advantageously reduce energy costs and may improve temperature control during cold or hot weather. In some embodiments, a first collection chamber and a first anaerobic digestion chamber may comprise a clay liner covered with an HPDE layer. Other impermeable plastic liners may also be suitable. An HPDE layer may advantageously allow for spray or flush cleaning without otherwise damaging the contents and surrounding of the chamber.

A first anaerobic digestion chamber of the present disclosure may comprise walls that are pre-stressed concrete panels. Constructing anaerobic chambers of the present disclosure from pre-stressed concrete panels may allow the system to withstand high velocity winds or endure tornadoes. A floor for a first anaerobic digestion chamber may comprise precast floor panels. Further, a roof of a chamber may be constructed to act as a relief panel to keep the walls from collapsing in case of an actual tornado. Installing relief panels on a roof may prevent over pressurization during adverse weather situations. Additionally or alternatively, the roof may also comprise hollow core concrete. Hollow core concrete may advantageously provide for heavy weight capacity, exceptional fire resistance, lower self-weight, superior acoustic insulation and thermal properties, and cost-effective construction solution. Hollow core concrete may also offer better design flexibility to builders, rapid speed of erection, and moderate use of raw material. In some embodiments, a roof may be slightly sloped to one side and made of hollow core reinforced concrete panels covered with a membrane.

A second anaerobic digestion chamber may be a plastic, metal, or lined pressure vessel. For example, a second anaerobic digestion chamber may be a stainless steel pressure vessel. In some embodiments, a second anaerobic digestion chamber may be rated from about 0 psig at about 50° F. to about 1200 psig at about 600° F. In some embodiments of the current disclosure, the tank may be agitated.

Embodiments of the present disclosure may advantageously be a green design or meet various standards to be considered a green operating facility. Some embodiments of the present disclosure may improve energy efficiency and allow for energy conservation. Further, recycling and containment of various fluid streams may prevent undesirable exposure to the environment and prevent adverse effects on the environment. Various green features that may benefit or prevent harm to the environment have already been described. Such features may include heating fluid streams to high temperatures, such as above about 140 degrees Fahrenheit to destroy potential pathogens. The heating of streams may effectively sterilize the fluids therein.

Embodiments of the present disclosure may advantageously satisfy various odor control and/or emission requirements. For example, some embodiments may provide for hydrogen sulfide emissions below 10 ppm, satisfying the OSHA 8 hour PEL. Some embodiments may provide for hydrogen sulfide emissions below detectable ranges. Accordingly, hydrogen sulfide emissions detected for some embodiments of the present disclosure may be about 0 ppm.

### Specific Example Embodiments

Specific example embodiments of a system for processing organic materials are illustrated in the accompanying Figures. The manner of carrying out the disclosure as shown and described is to be construed as illustrative only.

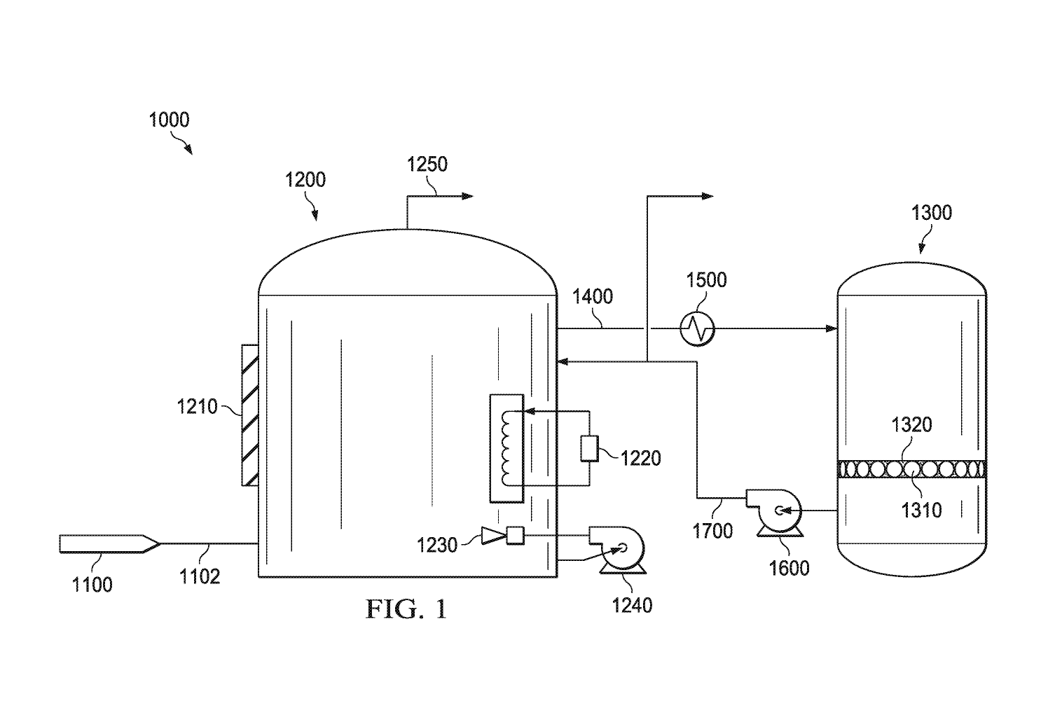

FIG. 1 illustrates an example system according to a specific example embodiment of the present disclosure. As depicted in FIG. 1, system 1000 for processing organic compounds may comprise various components. System 1000 may comprise first containment chamber 1100, first anaerobic digestion chamber 1200, and second anaerobic digestion chamber 1300.

First containment chamber 1100 may serve as a bio feed to provide organic compounds to first anaerobic digestion chamber 1200 via an organic compounds stream 1102. For example, first containment chamber 1100 may be a hog barn or a holding pit. Organic compounds, such as animal manure, may be collected in first containment chamber 1100. When particular quantities of organic compounds have been collected, the organic compounds may be pumped, transported, or otherwise provided to first anaerobic digestion chamber 1200.

First anaerobic digestion chamber 1200 may process organic compounds received from first containment chamber 1100. In some embodiments, first anaerobic digestion chamber 1200 may process organic compounds at about 110° F. First anaerobic digestion chamber 1200 may, in some embodiments, have volumes of up to 25,000,000 gallons and may process organic compounds for up to about 20 days to about 40 days. Residence time in a first anaerobic digestion chamber 1200 may vary. In some embodiments, residence time in first anaerobic digestion chamber 1200 may be about 0 days to about 40 days, or about 20 days to about 40 days. In some embodiments, for example, where first anaerobic digestion chamber 1200 is a lagoon, residence time may be about 1 year to about 7 years.

First anaerobic digestion chamber 1200 may comprise insulation 1210 and heater 1220. Heater 1220 may facilitate heating of first anaerobic digestion chamber 1200 to particular operating temperatures. Insulation 1210 may help maintain operating temperatures of first anaerobic digestion chamber 1200 and prevent undesirable loss of energy, thereby resulting in more energy efficiency.

First anaerobic digestion chamber 1200 may also comprise eductor 1230 and pump 1240. In some embodiments, pump 1240 may be a recirculation pump. A recirculation pump may use the liquid inside of first anaerobic digestion chamber 1200 to mix the contents of first anaerobic digestion chamber 1200. The addition of eductor 1230 will improve the plume of the liquid recirculated and draw in additional liquid inside first digestion chamber 1200 for use in the mixing of the chamber.

Further, first anaerobic digestion chamber 1200 may comprise a biogas outlet 1250. Biogas outlet 1250 may be used to remove particular gases from first anaerobic digestion chamber 1200. Biogas outlet may advantageously remove biogas from first anaerobic digestion chamber 1200 and transport biogas to another unit for further processing.

System 1000 may comprise fluid stream 1400 to allow fluids and/or materials to be provided from first anaerobic digestion chamber 1200 to second anaerobic digestion chamber 1300. For example, fluid stream 1400 may contain water from first anaerobic digestion chamber 1200. Water from first anaerobic digestion chamber 1200 may be rich in various nutrients, for example, carbohydrates, proteins, lipids, phosphorus, ammonium, and potassium oxide. Said water may be provided from first anaerobic digestion chamber 1200 to second anaerobic digestion chamber 1300 via fluid stream 1400. In some embodiments, heat exchanger 1500 may be disposed along fluid stream 1400.

Second anaerobic digestion chamber 1300 may receive fluids, such as water, from fluid stream 1400. Second anaerobic digestion chamber 1300 may, in some embodiments, operate at pressures of about 0 psig to about 1200 psig, and temperatures of about 200° F. to about 600° F. In some embodiments, operating pressures for a second anaerobic digestion chamber may be about 215 psig to about 1200 psig. Residence time in second anaerobic digestion chamber 1300 may be about 20 days to about 40 days. In some embodiments, residence time in second anaerobic digestion chamber 1300 may be about 30 minutes to about 40 days. Further, second anaerobic digestion chamber 1300 may comprise substrate 1310. In some embodiments, substrate 1310 may be lava rock. Bacteria 1320 may be growing on substrate 1310. The usage of substrate 1310 and the operating conditions of second anaerobic digestion chamber 1300 may advantageously provide for conditions suitable for bacteria 1320 to thrive.

System 1000 may further comprise pump 1600 disposed on recycle stream 1700. Recycle stream 1700 may return a fluid stream to first anaerobic digestion chamber 1200. Additionally or alternatively, recycle stream 1700 may be sent out of system 1000 by pump 1600. Recycle stream 1700, comprising unreacted constituents of volatile solids, but having vented product gases, helps move the equilibrium in first anaerobic digestion chamber 1200 further towards the product side. First anaerobic digestion chamber 1200, in combination with other chambers with recycle to first anaerobic digestion chamber 1200 or between themselves, with removal of effluent liquor, may prevent buildup from either second anaerobic digestion chamber 1300 or other stages from returning the preceding chambers, thereby increasing overall yield.

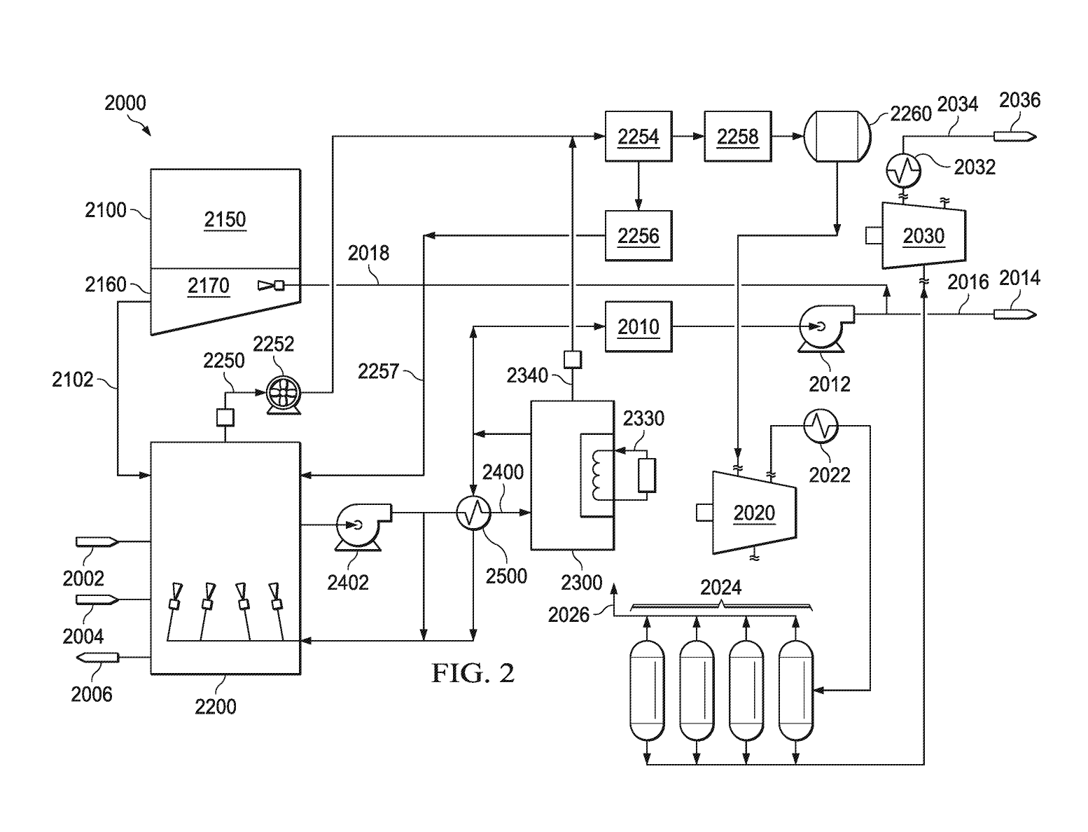

FIG. 2 illustrates another example system according to a specific example embodiment of the present disclosure. As depicted in FIG. 2, system 2000 may comprise various components. System 2000 may comprise first containment chamber 2100, which may be suitable for collecting organic compounds targeted for treatment or processing. In some embodiments, first containment chamber 2100 may be a hog barn. First containment chamber 2100 may comprise upper area 2150. Upper area 2150 may be a suitable living space for hogs or other livestock. First containment chamber 2100 may also comprise floor 2160, which may be a slatted floor. Slatted floor 2160 may allow organic compounds, such as animal manure, to fall through or otherwise be collected in lower area 2170. Lower area 2170 may be a bio-waste collection pit. First containment chamber 2100 may also receive wash water stream 2018, which may be provided from water storage 2010, or any other appropriate source. Wash water stream 2018 may allow organic compounds to be flushed into the lower area of 2170. Or, in some embodiments, wash water stream 2018 may be used to flush organic compounds out of lower area 2170 into organic compound stream 2102 and into first anaerobic digestion chamber 2200. Or, in some embodiments, wash water stream 2018 may promote cleaning of first containment chamber 2100. Organic compounds, such as animal manure may be provided via organic compound stream 2102 to first anaerobic digestion chamber 2200.

First anaerobic digestion chamber 2200 may receive organic compounds from first containment chamber 2100 via organic compound stream 2102. First anaerobic digestion chamber 2200 may also receive a bedding materials from bedding inlet 2002. Bedding inlet 2002 may provide bedding material such as grain-based pellets or oat husks. Such materials may advantageously provide for additional carbon to convert to methane. First anaerobic digestion chamber 2200 may also receive organic compounds in the form of livestock mortalities 2004. For example, hog mortalities may be introduced into system 2000 at first anaerobic digestion chamber 2200. Introduction of livestock mortalities 2004 may be done intermittently. In some embodiments, biosludge 2006 may collect within first anaerobic digestion chamber 2200. Accumulation of biosludge 2006 may be undesirable and may be removed intermittently. For example, biosludge may be removed from first anaerobic digestion chamber 2200 about every 10-15 years, or more frequently as may be advantageous.

Biogas generated in first anaerobic digestion chamber 2200 may be transported to condenser 2254 via a biogas stream 2250. Blower 2252 may be used to facilitate transport of biogas, such as and/or including methane gases, from first anaerobic digestion chamber 2200 to condenser 2254. After leaving blower 2252, biogas stream 2250 may pass through condenser 2254 to remove heat gained during any compression processes that may have been applied. Condenser 2254 may be of various types, including, in some embodiments, a ground cooler, an air-cooled heat exchanger, or a liquid-cooled heat exchanger. Condensate from the condenser 2254 may be collected and stored in condensate tank 2256. In some embodiments, condensate collected in condensate tank 2256 may be returned via condensate return stream 2257 to first anaerobic digestion chamber 2200.

Fluids generated in first anaerobic digestion chamber 2200 may be provided to second anaerobic digestion chamber 2300. For example, system 2000 may comprise fluid stream 2400 to allow fluids and/or materials to be provided from first anaerobic digestion chamber 2200 to second anaerobic digestion chamber 2300. Fluid stream 2400 may contain water from first anaerobic digestion chamber 2200. Water may be rich in various nutrients, for example, carbohydrates, proteins, lipids, phosphorus, ammonium, and potassium oxide. Pump 2402 may be used to facilitate transport of water from first anaerobic digestion chamber 2200 to second anaerobic digestion chamber 2300. Further, heat exchanger 2500 may be disposed along the path of fluid stream 2400 to facilitate heating and cooling operations within system 2000.

Second anaerobic digestion chamber 2300 may receive organic compounds such as water from first anaerobic digestion chamber 2200 via fluid stream 2400. Second anaerobic digestion chamber 2300 may comprise heater 2330 to heat said chamber. In some embodiments, second anaerobic digestion chamber 2300 may operate at about 2.5 psig and about 210° F. Second anaerobic digestion chamber 2300 may be sized to contain as much as about 20,000 gallons of water or organic compounds. Biogas generated in second anaerobic digestion chamber 2300 may be transported to condenser 2254 via a biogas stream 2340, similar to processing of biogas in first anaerobic digestion chamber 2200.

As explained above, biogases may be provided to condenser 2254 from either first anaerobic digestion chamber 2200 and/or second anaerobic digestion chamber 2300. Condensate from condenser 2254 may be stored in condensate tank 2256 and recycled to either first anaerobic digestion chamber 2200 and/or second anaerobic digestion chamber 2300. Biogas processed through condenser 2254 may be further treated via scrubber 2258. Scrubber 2258 may be a chemical scrubber suitable for use in removing sulfide gases. As explained in the present disclosure, various scrubbers may be used to facilitate the removing of sulfide gases.

Gases generated after being processed through scrubber 2258 may be stored at gas storage 2260. Gas storage may collect gases prior to transport to biogas compressor 2020. Gases from biogas compressor 2020 may then be provided to a plurality of methane purifiers 2024. Biogas may be purified by, for example, scrubbing, chemical absorption, pressure swing adsorption, membrane purification, cryogenic separation, or by additional biological processes. Gases from biogas compressor 2020 may pass through post-compression heat exchanger 2022 prior to being received at methane purifiers 2024. Tail gas 2026 from methane purifiers 2024 may be extracted for use. Further, biomethane gas may also be extracted from methane purifier 2024 and provided to biomethane compressor 2030 for treatment. Biomethane 2034 treated by a biomethane compressor 2030 may be cooled by biomethane compressor cooler 2032, and then provided as a biomethane supply 2036. Biomethane supply 2036 may be suitable for use as a fuel source (e.g. pipeline or CNG truck).

System 2000 may also comprise water storage 2010, which may provide or receive water from first anaerobic digestion chamber 2200. In some embodiments, water from water storage 2010 may be transported, as facilitated by water storage pump 2012, for further use. For example, as previously described, first containment chamber 2100 may receive wash water stream 2018 as provided from water storage 2010. As another example, water storage 2010 may provide water stream 2016 for use as an irrigation water supply 2014. Irrigation water supply 2014 may be suitable for land application and may decrease water waste and increase the overall energy efficiency of system 2000.

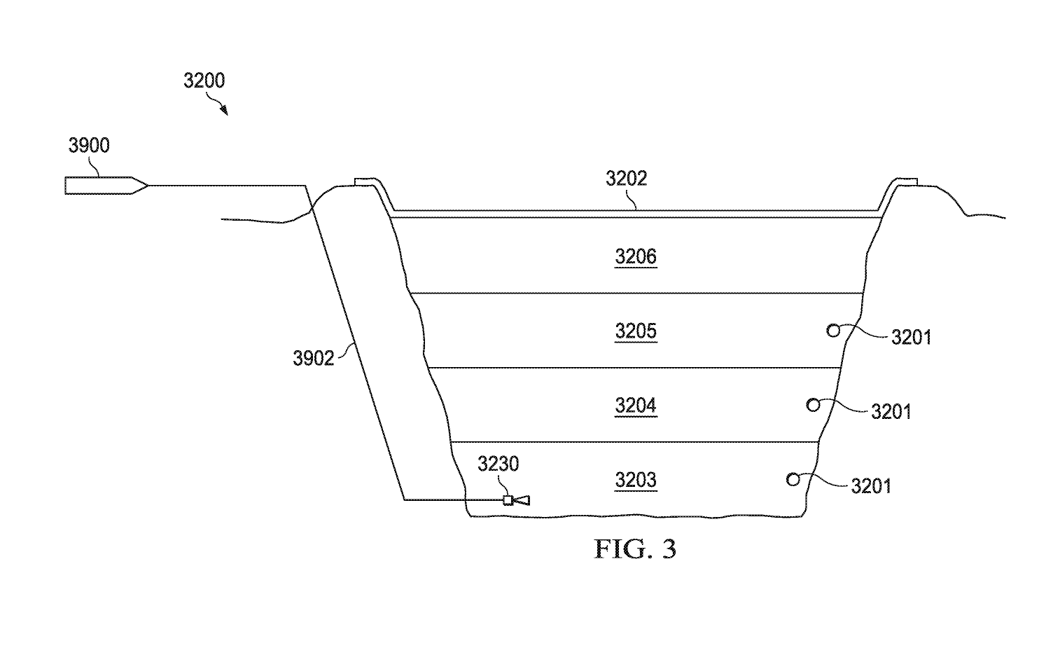

FIG. 3 illustrates a cross-sectional view of first anaerobic digestion chamber according to a specific example embodiment of the present disclosure. As depicted in FIG. 3, in some embodiments, first anaerobic chamber can be a lagoon 3200. Lagoon 3200 may comprise cover 3202. Cover 3202 may serve to protect lagoon 3200 from the environment, and cover 3202 may or may not be insulated. An interior of lagoon 3200 may comprise various layers. In ascending order, lagoon 3200 may comprise hydrolysis layer 3203, acidogenesis layer 3204, acetogenesis layer 3205, and methanogenesis layer 3206. In hydrolysis layer 3203, organics may be broken down into amino acids, fatty acids, and carbohydrates. In acidogenesis layer 3204, organics may be changed into short chain volatile acids, hydrogen, carbon dioxide, and other by-products. In acetogenesis layer 3205, products from acidogenesis layer 3204 may be converted into acetic acid, hydrogen, and carbon dioxide. In methanogenesis layer 3206 hydrogen and acetic acid may be converted to methane and carbon dioxide. The above descriptions and layer names are provided based on the predominant processes or reactions occurring in each layer. However, a portion of each process or reaction may take place in other layers. Thus, the above descriptions and layer names are provided by way of example only.

Lagoon 3200 may also comprise various fluid inlets/outlets 3201. Fluid inlets/outlets may be disposed at various positions in lagoon 3200, including any of the aforementioned layers 3203, 3204, 3205, and 3206. Fluid inlets/outlets may advantageously allow fluids to be added or withdrawn at various points in lagoon 3200. For example, water may be removed from any of the fluid inlets/outlets 3201.

Further, lagoon 3200 may be in fluid connection with a water recycle source 3900. In some embodiments, water recycle source 3900 may be a water storage unit comprising water collected and/or purified from a first anaerobic digestion chamber and/or a second anaerobic digestion chamber. Alternatively and/or additionally, water recycle source 3900 may comprise fresh water or recycle water from any other appropriate sources. Water recycle source 3900 may provide a recycle water stream 3902 to lagoon 3200. In some embodiments, eductor 3230 may be used as an inlet to provide water from water recycle source 3900 and recycle water stream 3902 into lagoon 3200.

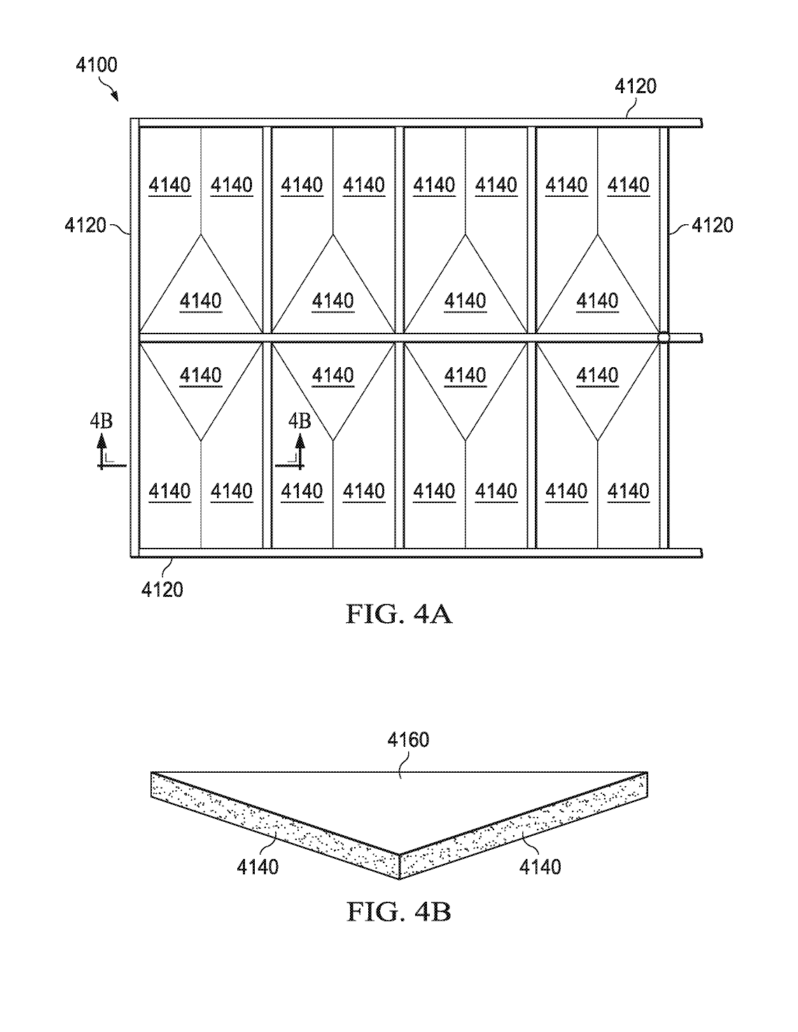

FIG. 4A illustrates an aerial view of a section of a first containment chamber according to a specific example embodiment of the present disclosure. FIG. 4B illustrates a cross-sectional view of a section of a first containment chamber according to a specific example embodiment of the present disclosure. As depicted in FIG. 4A, a first containment chamber according to the present disclosure may be a hog barn 4100. Hog barn 4100 may make use of various features including concrete masonry unit (CMU) walls 4120. CMU walls 4120 may isolate hog barn 4100, and may isolate particular sections of hog barn 4100. Dimensions of hog barn 4100 or particular sections of hog barn 4100 may vary depending on the needs of a particular embodiment. In some embodiments hog barn 4100 may have dimensions such as about 140 feet by about 40 feet and about 138 feet. For example, hog barn 4100 may have a width of about 100 feet to about 200 feet; a length of about 100 feet to about 200 feet, and a height of about 20 feet to about 60 feet. In an example embodiment, hog barn 4100 may have a width of about 138 feet, a depth of about 140 feet, and a height of about 40 feet. In some embodiments, sections of a hog barn 4100 may have dimensions of about 60 feet to about 70 feet in width, and about 10 feet to about 20 feet in depth.

Further, as shown in FIG. 4A and FIG. 4B, hog barn 4100 may comprise various sloped panels 4140. Sloped panels 4140 may be disposed below slatted floors 4160. The use of sloped panels 4140 and slatted floors 4160 may be advantageous for collecting organic compounds. For example, slatted floors 4160 may allow hogs or other animals to defecate freely within hog barn 4100. Animal manure may drop through slatted floors 4160 and collect at a lower portion or lower point in trenches below as a result of the angle of sloped panels 4140. In some embodiments, sloped panels 4140 may be arranged in sections, wherein each section comprise three sloped panels 4140. Angles of sloped panels 4140 may vary depending on the needs of a particular embodiment. In some embodiments, sloped panels 4140 may comprise compacted clay.

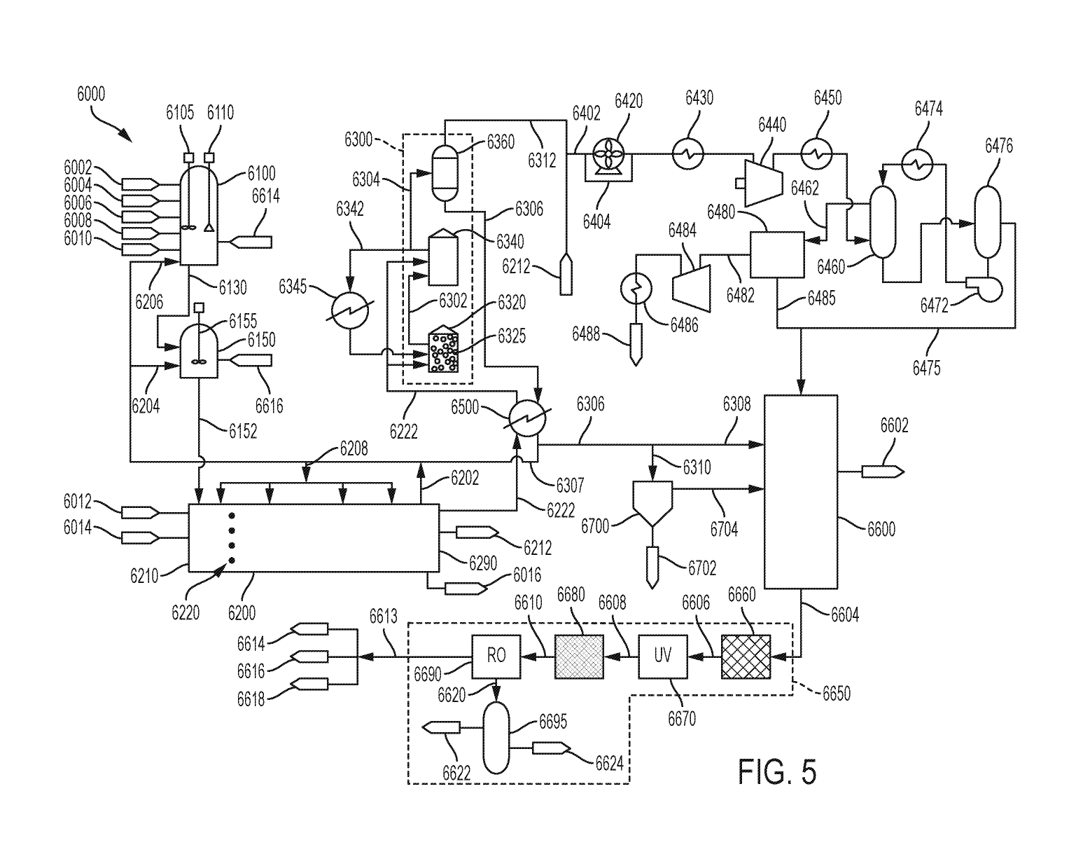

FIG. 5 illustrates another example system according to a specific example embodiment of the present disclosure. As depicted in FIG. 5, system 6000 may comprise various components. System 6000 may comprise first mixing chamber 6100 and a second mixing chamber 6150, which may be suitable for collecting and mixing organic compounds targeted for treatment or processing. In some embodiments, any number of mixing chambers may be used. The mixing chambers 6100 and 6150 may be pits, tanks, or in-line mixers suiting for mixing, and may be in-ground or above-ground.

Organic materials may be mixed together with other materials such as clean water or recycled fluids in the mixing chambers 6100 and 6150 using one or multiple methods including agitation and ultrasound. As shown in FIG. 5, first mixing chamber 6100 may include an agitator 6105 and an ultrasound mixer 6110 and the second mixing chamber 6150 may include an agitator 6155.

In some embodiments, multiple different organic materials may be mixed together and/or with other materials such as clean water or recycled fluids. Mixing may be performed in batch or continuous methods. The mixing chambers 6100 and 6150 may each have a volume of 10,000 gallons. In some embodiments, the mixing chambers may have a volume ranging from 5,000 gallons or lower to 50,000 gallons or larger. Batch mixing methods may require chambers 6100 and 6150 with volumes on the larger end of the spectrum.

Different types of organic compounds may be provided to the first mixing chamber 6100. As depicted in FIG. 5, animal manure from dry lot feedstock may be added to the first mixing chamber 6100 via feed 6002, daily scrape of animal manure from a feeding area may be added to the first mixing chamber 6100 via feed 6004, liquid manure from a dairy barn may be added to the first mixing chamber 6100 via feed 6006, and waste solids and other organic materials, such as grass, leaves, whey, buttermilk, and deceased livestock, may be added via feed 6008. In some embodiments, the organic material may be fed to the first mixing chamber 6100 via feeds 6002, 6004, 6006, 6008 by conveyor, pipeline or other methods, including but not limited to side haulers, dump trucks and huels.

Different organic materials may have different compositions of total solids (“TS”). Dry lot feedstock is animal manure that has been scraped from a feeding area, dairy barn, or other location and put in a pile. Dry lot feedstock from cows is typically 60% TS, although the TS can vary greatly depending upon a number of factors including the dwell time of the manure in the pile. Daily scrape from a cow feeding area is typically 15% TS and liquid manure from a cow dairy barn is typically about 2-6% TS, but again those compositions can vary depending upon a number of factors.

Total solids in animal manure are comprised of volatile solids and fixed solids, with the volatile solids being easier to convert to biogas. As manure dries outs, the total solids go from volatile to fixed. Dry lot feedstock, therefore, is typically high in fixed solids. When dry lot feedstock is added to the first mixing chamber 6100 via feed 6002, it may be desired to reduce the total solids to a suitable composition by the addition of clean water via stream 6010 or recycled water via stream 6206. The addition of water or other fluids to the organic material may also serve to convert fixed solids to volatile solids. In some embodiments, the total solids can be reduced to 20% in the first mixing chamber 6100; in other embodiments, a lower TS may be used, including down to 5 or 10%.

In a continuous mixing operation, organic material will be added to the first mixing tank 6100 in a continuous manner via feeds 6002, 6004, 6006, and/or 6008 and water or other fluid may be added via streams 6010 and/or 6206 in a continuous manner. The total solids may be controlled in the first mixing tank 6100 via different methods, including by controlling the rates of addition of the organic materials, water, and/or fluids. In one embodiment, the total solids is controlled to about 60% or lower. In another embodiment, the total solids is controlled to about 20% or lower. In yet another embodiment, the total solids is controlled to about 5% or lower.

Organic material spill over from the first mixing chamber 6100 will be directed to the second mixing chamber 6150 via stream 6130. As shown in FIG. 5, bacteria-containing recycled fluid from the first anaerobic digestion chamber 6200 may be added to the second mixing chamber 6150 via stream 6204. Organic material from stream 6130 may be mixed with stream 6204 in the second mixing chamber 6150 using agitator 6155 to provide intimate contact between the organic material and the bacteria before it is sent to the first anaerobic digestion chamber 6200. In some embodiments, the second mixing chamber 6150 may be a static in-line mixer. The total solids may be controlled in the second mixing chamber 6150 via different methods, including by controlling the rates of addition of the organic materials and fluids via streams 6130 and 6204. In one embodiment, the total solids may be controlled to 5%. In another embodiment, the total solids may be controlled to 4-10%. It yet other embodiments, the total solids may be controlled to as high as 60% or as low as 1-2%.

First anaerobic digestion chamber 6200 may receive organic compounds from the second mixing chamber 6150 via organic compound stream 6152. In the alternative, organic materials may be added directly to the first anaerobic digestion chamber 6200, bypassing the mixing chambers 6100 and 6150. The first anaerobic digestion chamber 6200 may be a mesophilic digestion system for generating biogas from organic compounds with operating temperatures above about 60° F. and up to approximately 113° F.

As shown in FIG. 5, the first anaerobic digestion chamber 6200 may be an in-ground lagoon that is about 250 feet wide by about 1000 feet long by about 16 to 20 feet deep, and may have a first, inlet end 6210 and a second, outlet end 6290. First anaerobic digestion chamber 6200 may receive the organic compounds via stream 6152 at the first, inlet end 6210 and may also receive a bedding materials from bedding inlet 6012 at the first, inlet end 6210. Bedding inlet 6012 may provide bedding material such as grain-based pellets or oat husks. Such materials may advantageously provide for additional carbon to convert to methane. First anaerobic digestion chamber 6200 may also receive organic compounds in the form of livestock mortalities 6014 at the first, inlet end 6210. For example, cow mortalities may be introduced into system 6000 at first anaerobic digestion chamber 6200. Introduction of livestock mortalities 6014 may be done intermittently.

As shown in FIG. 5, first anaerobic digestion chamber 6200 may include one or more agitation mixers and/or ultrasound mixers that form a line or barrier 6220 along a width of the first anaerobic digestion chamber 6200. The line of mixers 6220 may be spaced a sufficient distance from the inlet end 6210 of the first anaerobic digestion chamber 6200 where it can mix in floating biodegradable material. In various embodiments, the line of mixers 6220 may be spaced about 125 feet or less from the inlet end 6210 up to 200 feet or more from the inlet end 6210.

In some embodiments, liquids in the first anaerobic digestion chamber 6200 may take from one to two months to get from the inlet end 6210 to the outlet end 6290, while solids may take from three to six months to get from the inlet end 6210 to the outlet end 6290. In some embodiments, biosludge 6016 may collect within first anaerobic digestion chamber 6200. Accumulation of biosludge 6016 in the first anaerobic digestion chamber 6200 may be undesirable and may be removed intermittently from the second, outlet end 6290 of the first anaerobic digestion chamber 6200. For example, biosludge may be removed from first anaerobic digestion chamber 6200 about every 10-15 years, or more frequently as may be advantageous.

To provide motive force for the biosludge to move it from the inlet end 6210 to the outlet end 6290, fluid may be pulled from outlet end of the first anaerobic digestion chamber 6200 via stream 6202 and re-injected in the first anaerobic digestion chamber 6200 at one or more locations along its length via stream 6208. As shown in FIG. 5, stream 6208 may be injected at four locations, two on each side of the mid-point of the first anaerobic digestion chamber 6200. In some embodiments, stream 6208 may be re-injected into the top of the hydrolysis layer (layer 3203 in FIG. 3) or into the bottom of the acidogenesis layer (layer 3204 in FIG. 3), or both, to provide motive force to move biosludge 6016 and/or to roll the biosludge 6016 to prevent encapsulation of bacteria. Injection of stream 6208 may also dilute the material at or near the hydrolysis and/or acidogenesis layers to enhance the production of methane forming material.

As shown in FIG. 5, and discussed above, fluid pulled from the outlet end of the first anaerobic digestion chamber 6200 via stream 6202 may also be directed to one or both of the first mixing chamber 6100 and the second mixing chamber 6150 via streams 6206 and 6204, respectively.

In one embodiment, the fluid for streams 6202, 6204, and/or 6206 may be pulled from different layers as determined by the reaction kinetics and the temperature of the first anaerobic digestion chamber 6200. It may be necessary to pull from the acidogenesis layer (layer 3204 in FIG. 3). In other embodiments, fluid for streams 6202, 6204, and/or 6206 may be pulled from the hydrolysis layer (layer 3203 in FIG. 3), and/or the acetogenesis layer (layer 3205 in FIG. 3), or a combination of any of the layers.

To improve the yield and rate of biogas generation of the system 6000, a second anaerobic digestion chamber 6300 may also receive organic compounds such as fluid from the first anaerobic digestion chamber 6200 via stream 6222. In some embodiments, second anaerobic digestion chamber 6300 may receive organic compounds directly or indirectly from one or more of the mixing chambers 6100 and/or 6150. Fluid for stream 6222 may be pulled from the acidogenesis layer (layer 3505 in FIG. 3) and/or the methanogenesis layer (layer 3506 in FIG. 3). In some embodiments, stream 6222 may branch off from stream 6202 or vice versa. The second anaerobic digestion chamber 6300 may be a thermophilic digestion system for generating biogas from organic compounds with operating temperatures above about 113° F. and up to approximately 165° F. The high temperature of the thermophilic digestion system promotes the break down of long chained organics.

Heat from fluids leaving the second anaerobic digestion chamber 6300 may be regenerated for use in heating fluids entering the second anaerobic digestion chamber 6300. As shown in FIG. 5, a counterflow heat exchanger 6500 may be used to transfer heat from stream 6306 leaving the second anaerobic digestion chamber 6300 to the stream 6222 entering the second anaerobic digestion chamber 6300. Under certain operating conditions, use of heat exchanger 6500 may reduce the total heat requirement of the second anaerobic digestion chamber 6300 from 17 MMBTU/hr (17,000,000 BTU/hr) down to 2 MMBTU/hr or less. The total heat requirement may vary depending upon numerous factors, including the size of the total system 6000 and throughput.

The thermophilic system (i.e., the second anaerobic digestion chamber 6300) may include a make-up heater system which will vary generally from less than 2 MMBTU/hr to 17 MMBTU/hr. The make-up heat will be necessary due to the heat loss through the entire thermophilic system and inability to recover all of the heat in heat exchanger 6500. The residence time in the thermophilic system can range from a few minutes to several days.

In one embodiment, the system 6000 may include a supplemental heater 6345 to supplement the heat provided by the heat exchanger 6500, such the total heat requirement of the second anaerobic digestion chamber 6300 may be met. In some embodiments, fluid from the second anaerobic digestion chamber 6300 may be recirculated through supplemental heater 6345. In one embodiment shown in FIG. 5, fluid may be pulled from the second digestion tank 6340 via line 6342, directed through supplemental heater 6345, and re-injected into the second anaerobic digestion chamber 6300 at first digestion tank 6320. The supplemental heater 6345 may include a hot oil system, wherein oil may be heated using natural gas or biogas. The hot oil may then be supplied to the shell side of a shell and tube heat exchanger, with stream 6342 being supplied to the tube side. As an alternative to the hot oil system and shell and tube heat exchanger, the system 6300 may heat the stream 6342 using direct fire by natural gas or biogas or a steam boiler fired by either biogas or natural gas, or other methods. In some embodiments, the supplemental heater 6345 may provide about 6 MMBTU/hr.

The second anaerobic digestion chamber 6300 may be comprised of one or more tanks. As shown in FIG. 5, in one embodiment, the second anaerobic digestion chamber 6300 may comprise three tanks connected in series: organic material may be directed to a first thermophilic digestion tank 6320 via stream 6222, then to a second thermophilic digestion tank 6340 via stream 6302, and then to a biogas separation tank 6360 via stream 6304. Fluid leaves the biogas separation tank 6360 via stream 6306, where it may be directed to the crossflow heat exchanger 6500, and then to an aerobic reaction chamber 6600 or other locations.

During certain operating conditions, stream 6222 may be used to direct organic material from the first anaerobic digestion chamber 6200 to the second thermophilic digestion tank 6340. For instance, during certain processing conditions where removal of the solid sludge from the bottom of the first anaerobic digestion chamber 6200 is necessary or desirable, bypassing of the lava 6325 bacterial bed in the first digestion tank 6320 may be required to prevent fouling. During such operating conditions, sludge from the bottom of the first anaerobic digestion chamber 6200 will be heated to sterilization temperatures in the second anaerobic digestion chamber 6300. During such operating conditions, it may be desired to direct all of the fluid in stream 6306 through the solid/liquid separator 6700 via stream 6310, whereby sludge from the bottom of the first anaerobic digestion chamber 6200 may be converted to compost.

In one embodiment, the first and second thermophilic digestion tanks 6320, 6340 may each have a volume of 45,000 gallons. Larger or smaller tanks may be used depending upon a number of factors, for example the capacity of the system 6000 and whether a batch or continuous process is used. The first thermophilic digestion tank 6320 may comprise substrate 6325. In some embodiments, substrate 6320 may be lava rock. Bacteria may be growing on substrate 6325. The usage of substrate 6325 and the operating conditions of second anaerobic digestion chamber 6300 may advantageously provide for conditions suitable for bacteria to thrive. The second thermophilic digestion tank 6340 may also comprise substrate. As shown in FIG. 5, second thermophilic digestion tank 6340 does not comprise substrate, and serves to provide the organic material residence time at high temperate for the generation of biogas. The biogas separation tank 6360 may be a gas/liquid separation tank with a volume of 10,000 gallons. As with the first and second thermophilic digestion tanks 6320, 6340, the size of the biogas separation tank 6360 may vary depending upon a number of factors.

Fluid may leave the second anaerobic digestion chamber 6300 via stream 6306. As shown in FIG. 5, after passing through the heat exchanger 6500, fluid in stream 6306 may be directed to one or any combination of an aerobic reaction chamber 6600 via stream 6308, a solid/liquid separator 6700 via stream 6310, a first anaerobic digestion chamber via streams 6307 and 6208, a second mixing chamber 6150 via streams 6307 and 6204, and/or a first mixing chamber 6100 via streams 6307 and 6206. The solid/liquid separator 6700 may be any suitable solid/liquid separator, such as a gravity based separator or a centrifuge. Solids 6702 may be pulled from the solid/liquid separator 6700 and used as compost, while the liquids may be sent to the aerobic reaction chamber 6600 via stream 6704 or used elsewhere in the system 6000 as recycled fluid. In some embodiments, all of the fluid leaving the second anaerobic digestion chamber 6300 via stream 6306 is passed through the solid/liquid separator 6700. In other embodiments, only a portion of the stream 6306 is passed through the solid-liquid separator 6700, with the remainder going to the aerobic reaction chamber 6600 via stream 6308. In one particular embodiment, around twenty to thirty gallons per minute may be passed though the solid-liquid separator 6700, with the remainder going to the aerobic reaction chamber 6600 via stream 6308.

As discussed above, the fluid from the second anaerobic digestion chamber 6300 passing through the heat exchanger 6500 may be sent forward to the aerobic reaction chamber 6600 or recycled to the first anaerobic digestion chamber 6200. The fluid sent to the aerobic reaction chamber 6600 is used to balance the water usage. The majority of the fluid being recycled to the first anaerobic digestion chamber 6200 increases the yield similar to a reflux stream in a distillation system. The recycled fluid may be lower in certain organic constituents and when recycled to the first anaerobic digestion chamber 6200 increases the reaction rate. The recycled fluid may also help stabilize the temperature of the first anaerobic digestion chamber 6200. The recycled fluid may be injected into the layer above the hydrolysis layer to promote rates and increase movement in the hydrolysis layer. The fluid may also be recycled to the first mixing chamber 6100 as the mesophilic bacteria has already been reduced by the higher thermophilic temperatures and the ultrasound will not have a substantial detrimental effect on the mesophilic bacteria. In contrast, the ultrasound treatment will further breakdown the bacteria to make it more available to treatment in the first anaerobic digestion chamber 6200 increasing the yield.

The aerobic reaction chamber 6600 may serve one or more purposes. In one embodiment, the aerobic reaction chamber 6600 is a storage vessel for recycled water containing fertilizer. In some embodiments, the aerobic reaction chamber 6600 may be a reactor vessel used to react hydrogen sulfide rich gas streams. In some embodiments, the aerobic reaction chamber 6600 may be allowed to evaporate to concentrate the fertilizer and reduce the energy needed to make a commercial grade liquid fertilizer. In some embodiments, the aerobic reaction chamber 6600 may be a pond or lagoon. In one embodiment, the pond or lagoon may be about 250 feet wide by about 1000 feet long by about 16 to 20 feet deep.

In operation, the aerobic reaction chamber 6600 may comprise liquid fertilizer. Under certain operating conditions, the aerobic reaction chamber 6600 may comprise about 4% liquid fertilizer, with primary constituents including soluble and suspended sulfur, potash, phosphate, and nitrogen. The fluid in the aerobic reaction chamber may be directly applied to land via stream 6602, or may be directed to a purification system 6650 via stream 6604.

A purification system 6650 may comprise one or more filters to clean the fluid stream 6604 and concentrate the fertilizer in fluid stream 6604. As shown in FIG. 5, a purification system 6650 may comprise a plurality of filters connected in series. Fluid from the aerobic reaction chamber 6600 may enter a first (gross or coarse) filter 6660 via stream 6604 to remove large particulates and chunks. Fluid may then be directed to an ultraviolet light or ultrasound treatment system 6670 via stream 6606 to kill bacteria and prevent membrane fouling in subsequent purification steps. Fluid may then be directed to a second (fine) filter 6680 via stream 6608 to remove smaller particles. In some embodiments, the second filter 6680 may remove particles having a size greater than approximately 20 μm. Fluid may then be directed to a reverse osmosis unit 6690 via stream 6610. The reverse osmosis unit 6690 may generate two fluid streams, a recycled water stream 6613 and a concentrated fertilizer stream 6620. The recycled water stream 6613 may be sent back to the first mixing chamber 6100 via stream 6614 or to the second mixing chamber 6150 via stream 6616, or may be applied directly to land via stream 6618. The fertilizer content of the concentrated fertilizer stream 6620 may be higher than the fertilizer content of the stream 6604. Under certain operating conditions, the concentrated fertilizer stream 6620 may have a fertilizer content of about 12-15%, or up to about 20%. The concentrated fertilizer stream 6620 may be applied to land, or may be sent via stream 6620 to an evaporator 6695 where the fertilizer can be further concentrated to a commercially significant level. In one embodiment, the evaporator 6695 may be a rising film one stage evaporator. In other embodiments, the evaporator 6695 may be a triple stage evaporator. The evaporator may generate two streams, a vapor stream 6622, which may be condensed and used as recycled water in the same manner as stream 6613, and a highly concentrated fertilizer stream 6624 that may be direct land applied or collected and commercialized. Heat from the evaporator 6695 may be recovered and used elsewhere in the process.

The fertilizer content of the highly concentrated fertilizer stream 6624 may be higher than both the fertilizer content of the stream 6604 and the fertilizer content of the concentrated fertilizer stream 6620. Under certain operating conditions, the highly concentrated fertilizer stream 6624 may have a fertilizer content of about 30%. Stream 6624 may be utilized as commercial liquid fertilizer or may be further processed to make solid fertilizer.

Biogas generated in the first anaerobic digestion chamber 6200 may be transported to a cooler 6430 via biogas stream 6212. Similarly, biogas generated in the second anaerobic digestion chamber 6300 may be transported to a cooler 6430 via biogas stream 6312. As shown in FIG. 5, biogas streams 6212 and 6312 may merge into biogas stream 6402 prior to entering the cooler 6430, and may include an inline blower 6420 to facilitate transport of the biogas and to increase the pressure of the biogas for subsequent processes. In some embodiments, the blower 6420 may increase the pressure of the biogas to about 2 psig or higher. In some embodiments, a bypass 6404 may be provided around the blower 6420. Bypass 6404 may be used during certain operating conditions when the biogas in stream 6402 has sufficient pressure.

After leaving or bypassing the blower 6420, biogas stream 6402 may pass through cooler 6430 to remove heat gained during any compression processes that may have been applied. Cooler 6430 may be of various types, including, in some embodiments, a ground cooler, an air-cooled heat exchanger, or a liquid-cooled heat exchanger. In some embodiments, cooler 6430 may be sized to reduce the temperature of biogas to about 150° F. or less. Condensate from the cooler 6430 may be collected and sent to the first anaerobic digestion chamber 6200 or elsewhere.

After leaving the cooler 6430, biogas stream 6402 may be transported to compressor 6440 which raises the pressure of the biogas. In some embodiment, the biogas may be compressed by the compressor 6440 to 100-150 psig. After leaving the compressor 6440, biogas stream 6402 may pass through cooler 6450 to remove heat gained during any compression processes that may have been applied. Cooler 6450 may be of various types, including, in some embodiments, a ground cooler, an air-cooled heat exchanger, or a liquid-cooled heat exchanger. In some embodiments, cooler 6450 may be sized to reduce the temperature of biogas to about 150° F. or less. Condensate from the cooler 6450 may be collected and sent to the first anaerobic digestion chamber 6200 or elsewhere.

After leaving the cooler 6450, biogas stream 6402 may then be transported to one or more methane purifiers. In some embodiment, biogas stream 6402 may be purified in multiple stages. In one embodiment, biogas stream 6402 may be directed to a first methane purifier before being directed to a second methane purifier.

As shown in FIG. 5, the first methane purifier may be a water scrubber 6460, which uses water to pull carbon dioxide (CO₂) and other contaminants, such as hydrogen sulfide (H₂S) and ammonia, from the methane in the biogas stream 6402. CO₂- and H₂S-rich water leaving the water scrubber 6460 may be transported to a release tank 6470, where a reduction in pressure draws the gases out of the water. In some embodiments, the pressure is dropped by about 100 psi. In one embodiment, the pressure in release tank 6470 may be about 5-25 psig. Pump 6472 may be used to direct water from the release tank 6470 through cooler 6474 and back to the water scrubber 6460. In some embodiments, cooler 6474 reduces the temperature of the water to about 45° F.

In one embodiment, the water scrubber 6460 may be a packed column falling film sieve tray. In another embodiment, the water scrubber 6460 may be a diffuser in a water containing tank. The purpose of the water scrubber 6460 may be to remove trace organics and hydrogen sulfide.

Under certain operating conditions, using a water scrubber 6460 as the first methane purifier 6460 may remove a substantial amount of the CO₂ from the biogas stream 6402, along with removing similar amounts of other contaminants, such as sulfides (including Hydrogen Sulfide—H₂S) and ammonia. In one embodiment, the first methane purifier may reduce a majority of the CO₂ from the biogas stream 6402. For instance, the first methane purifier may eliminate from 50% to 90% of the CO₂ from the biogas stream 6402. In other embodiments, the first methane purifier may eliminate from 5% or less to 90% or 95% or more of the CO₂ from the biogas stream 6402.

In one embodiment, biomethane 6462 leaving the water scrubber 6460 may be suitable for pressurization and use as a fuel source (e.g., pipeline or CNG truck). In another embodiment, biomethane 6462 leaving the water scrubber 6460 may be purified in a second methane purifier. As shown in FIG. 5, the second methane purifier may be a pressure swing absorption (PSA) unit 6480, which reduces the CO₂ and other contaminant levels of the biomethane to pipeline-acceptable levels. There are a number of commercial PSA units that may be suitable for use, as the PSA unit 6480, including units manufactured by Guild.

Biomethane 6482 leaving the PSA unit 6480 may be suitable for pressurization and use as a fuel source (e.g., pipeline or CNG truck). As shown in FIG. 5, biomethane 6482 may be transported to compressor 6484, which elevates the pressure of the biomethane 6482 to sufficient levels. Biomethane 6482 leaving the compressor 6484 may be cooled using cooler 6486.

As shown in FIG. 5, the CO₂, H₂S, and other contaminants pulled from the biomethane streams 6462 and 6482 by the water scrubber 6460 and PSA unit 6480 may directed to the aerobic reaction chamber 6600 via waste gas streams 6475 and 6485. In one embodiment, the waste gas streams 6475 and 6485 are injected into the aerobic reaction chamber 6600 at a location where the H₂S may be biologically converted in an anaerobic process into elemental sulfur (S) and concurrently in an aerobic process into sulfate (SO₄). In some embodiments, the waste gas streams 6475 and 6485 are injected into the aerobic reaction chamber at about 5 or more feet below the surface of the aerobic reaction chamber. In other embodiments, the waste gas streams 6475 and 6485 are injected into the aerobic reaction chamber at about two to thirty feet below the surface of the aerobic reaction chamber. This operation can alternatively be done ex vitro, in a separate scrubber unit using aerobic liquid and the gas streams 6475 and 6485.

One of ordinary skill in the art may make various changes in the shape, size, number, and/or arrangement of parts without departing from the scope of the instant disclosure. For example, the position and number of pumps and/or heat exchanges may be varied. In some embodiments, the size of a device and/or system may be scaled up or down to suit the needs and/or desires of a practitioner. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Persons skilled in the art may make various changes in methods of preparing and using a composition, device, and/or system of the disclosure. For example, a system may be prepared and or used as appropriate for animal and/or human waste.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value +/− about 10%, depicted value +/− about 50%, depicted value +/− about 100%) and/or a range endpoint. With respect to the former, a value of 50 depicted in an example, table, and/or drawing may form the basis of a range of, for example, about 45 to about 55, about 25 to about 100, and/or about 0 to about 100.

All or a portion of a device and/or system for processing organic compounds may be configured and arranged to be disposable, serviceable, interchangeable, and/or replaceable. These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

In certain cases, components have been omitted for clarity purposes. For instance, it would be known that pumps may be necessary or desired to facilitate the transfer of material from one component to the next, depending upon various operating conditions, such as the respective pressures of the two components.

The title, abstract, background, and headings are provided in compliance with regulations and/or for the convenience of the reader. They include no admissions as to the scope and content of prior art and no limitations applicable to all disclosed embodiments.

What is claimed is:

1. A system for removing contaminants from a biogas stream generated from organic compounds, the system comprising:
a first methane purifier, wherein the first methane purifier is configured to receive the biogas stream and remove at least some contaminants from the biogas stream, whereby the first methane purifier generates a first biomethane stream and a first contaminant-rich stream;
a second methane purifier, wherein the second methane purifier is configured to receive the first biomethane stream and remove at least some contaminants from the first biomethane stream, whereby the second methane purifier generates a second biomethane stream and a second contaminant-rich stream.

2. The system of claim 1, wherein the contaminants include one or more of carbon dioxide, hydrogen sulfide, ammonia, and trace amounts of organics.

3. The system of claim 2, wherein the first methane purifier is configured to remove at least about 50% of the carbon dioxide present in the biogas stream.

4. The system of claim 2 wherein the first methane purifier is configured to remove between about 80% and about 90% of the carbon dioxide present in the biogas stream.

5. The system of claim 1, wherein the first methane purifier is a water scrubber and the second methane purifier is a pressure swing adsorption unit.

6. The system of claim 2 further comprising a chamber configured to receive bacteria-containing water from the generation of the biogas, wherein at least one of the first contaminant-rich stream and the second contaminant-rich stream are injected into the chamber.

7. The system of claim 6, wherein at least one of the first contaminant-rich stream and the second contaminant-rich stream are injected into the chamber below a surface of the bacteria-containing water contained in the chamber.

8. The system of claim 6, wherein at least one of the first contaminant-rich stream and the second contaminant-rich stream are injected into the chamber at about two to thirty feet below a surface of the bacteria-containing water contained in the chamber.

9. The system of claim 1, wherein the first methane purifier is a water scrubber configured to remove between at least about 50% of the carbon dioxide present in the biogas stream and the second methane purifier is a pressure swing adsorption unit.

10. A system for processing a hydrogen sulfide-containing gas stream, the system comprising:
a chamber containing water and configured to receive the hydrogen sulfide-containing gas stream at a location having sufficient carbon dioxide, oxygen and bacteria, whereby the sulfide is converted to one or more of sulfur or sulfate.

11. The system of claim 10, wherein the bacteria is present in the chamber and the carbon dioxide is contained in the hydrogen sulfide-containing gas stream.

12. The system of claim 10, wherein the chamber is configured to receive the hydrogen sulfide-containing gas below a surface of the water.

13. The system of claim 10, wherein the chamber is configured to receive the hydrogen sulfide-containing gas about two to thirty feet below a surface of the water.

14. The system of claim 10, further comprising at least one methane purifier configured to receive a biogas stream generated from organic compounds and remove at least some contaminants from the biogas stream, whereby the at least one methane purifier generates a biomethane stream and the hydrogen sulfide-containing stream.

15. A system for processing a material comprising one or more organic compounds for the recovery of biogas, the system comprising:
at least one anaerobic digestion chamber configured to receive the organic compounds from a mixing chamber, wherein the mixing chamber includes an ultrasonic mixer configured to increase the bioavailability of the organic compounds.

16. A system for concentrating a fertilizer in a discharge from an anaerobic digester, the system comprising:
a sterilization unit using one or more of ultrasound and ultraviolet light treatments to eliminate bacteria from the discharge; and,
a reverse osmosis unit configured downstream of the sterilization unit to concentrate the fertilizer in the discharge.

17. The system of claim 16, further comprising at least one filter to remove particulates from the discharge.

18. The system of claim 16, further comprising an evaporator configured downstream of the reverse osmosis unit to further concentrate the fertilizer in the discharge.

19. The system of claim 16, wherein the discharge is a thermophilic treated liquor.

20. The system of claim 19, wherein the anaerobic digestion chamber is configured to digest organic compounds under thermophilic conditions, whereby the at least one anaerobic digestion chamber generates a biogas stream and the thermophilic treated liquor.

21. A system for extracting compost from a discharge from at least one anaerobic digester in a two-stage anaerobic, thermophilic digestion system, wherein the discharge comprises solids and liquids, the system comprising a separator configured to receive the discharge and separate the solids from the liquids.

22. The system of claim 21, wherein the separator is a centrifuge.

23. The system of claim 21, wherein the liquids are returned to at least one of the at least one anaerobic digester.

24. A system for processing a material comprising one or more organic compounds, the system comprising:
a first anaerobic chamber configured to receive organic compounds and generate biogas using a mesophilic process, wherein a fluid in the first anaerobic chamber has multiple layers that comprises at least an acetogenesis layer and a methanogenesis layer;
a second anaerobic chamber configured to receive the fluid drawn from one or both of the acetogenesis layer and the methanogenesis layer and to generate biogas using a thermophilic process.
